(19) United States
(12) Patent Application Publication
(10) Pub. No.: US 2014/0077681 A1
(43) Pub. Date: Mar. 20, 2014

(54) ENHANCED ALUMINUM THIN FILM COATING FOR LAMP REFLECTORS

(71) Applicant: GENERAL ELECTRIC COMPANY, Shelton, CT (US)

(72) Inventors: Peter William BROWN, Twinsburg, OH (US); Jiawei Li, Avon Lake, OH (US); Tianji Zhao, Highland Heights, OH (US)

(73) Assignee: General Electric Company, Shelton, CT (US)

(21) Appl. No.: 13/622,124

(22) Filed: Sep. 18, 2012

(51) Int. Cl. H01K 1/32; H01K 1/30

(52) U.S. Cl. 313/111; 313/113

(57) ABSTRACT

Reflector lamps and their methods of manufacture are provided. The reflector lamp includes a parabolic housing defining an interior surface; a light source positioned within the housing; a reflector layer (e.g., including aluminum) on the interior surface of the housing; and an optical interference multilayer coating on the reflective layer. The optical multilayer coating generally includes a plurality of alternating low index layers and high index layers, with the low index layers having a refractive index that is about 1.38 to about 1.55 at 550 nm and the high index layers having a higher refractive index than the low index layers.

### FIELD OF THE INVENTION

Embodiments of this invention relate to a reflector coating and a method of preparation thereof for use in reflector lamps.

### BACKGROUND OF THE INVENTION

Reflector lamps are widely used in spot lighting, head lamps, and the like. A recent area of emphasis in reflector lamp design has been to increase energy efficiency. Energy efficiency is typically measured in the industry by reference to the lumens produced by the lamp per watt of electricity input to the lamp (LPW). Obviously, a lamp having high LPW is more efficient than a comparative lamp demonstrating a low LPW.

One of the most commonly used reflector coatings is aluminum film, which typically is deposited on the surface of a reflector either by thermal evaporation or sputtering. Manufacture costs are low and the film is stable at lamp operating temperatures over the life of the lamp. Reflectivities of the film in the visible spectrum are about 88-89%, such that conventional lamps incorporating the aluminum films are able to convert about 70% of the light emitted from the lamp filament tube to luminous output.

An alternative reflector coating includes silver. Silver films have a higher reflectivity and are used in optics, electronics, and in lighting. For example, one known PAR silver-coated lamp's reflectance is about 95-98%, thus the lamps are typically convert about 80-85% of the light emitted from the lamp filament tube to luminous output, a 15% lumen gain is thus expected. However, silver films tend to become tarnished over time, especially at the lamp operating temperature, which can be relatively high. Additionally, the use of such silver films is somewhat limited due to its increased material costs.

Thus, a need exists to increase the reflectance of aluminum films for use in reflector lamps. In particular, a need exists in the art to mimic the performance of silver films while avoiding their associated drawbacks.

### BRIEF DESCRIPTION OF THE INVENTION

Aspects and advantages of the invention are set forth below in the following description, or may be obvious from the description, or may be learned through practice of the invention.

Reflector lamps are generally provided. In one embodiment, a reflector lamp is generally provided that includes a parabolic housing defining an interior surface; a light source positioned within the housing; a reflector layer (e.g., including aluminum) on the interior surface of the housing, and an optical interference multilayer coating on the reflective layer. The optical multilayer coating generally includes a plurality of alternating low index layers and high index layers, with the low index layers having a refractive index that is about 1.38 to about 1.55 at 550 nm and the high index layers having a higher refractive index than the low index layers.

Methods are also generally provided of forming a reflector lamp. In one embodiment, a reflector layer (e.g., including aluminm) can be formed on the interior surface of the housing. Alternating low index layers and high index layers can then be deposited onto the reflective layer to form an optical interference multilayer coating. Prior to or after forming the reflector layer and/or the optical interference multilayer coating, a light source can be positioned within the housing.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a cross-sectional view of an exemplary lamp in accordance with one embodiment of the present invention;

FIG. 2 is a perspective view of another exemplary lamp in accordance with one embodiment of the present invention;

FIG. 3 is a cross-sectional view of yet another exemplary lamp in accordance with one embodiment of the present invention;

FIG. 4 is an enlarged cross-sectional view of the reflector housing of any of the exemplary lamps shown in FIGS. 1-3;

FIG. 5 is a cross-sectional view of one embodiment of the housing including an optical interference multilayer coating on the reflector layer; and

FIG. 6 is an enlarged view of the optical interference multilayer coating shown in FIG. 5.

Repeat use of reference characters in the present specification and drawings is intended to represent the same or analogous features or elements.

### DETAILED DESCRIPTION OF THE INVENTION

Reference will now be made in detail to present embodiments of the invention, one or more examples of which are illustrated in the accompanying drawings. This detailed description uses numerical and letter designations to refer to features in the drawings. Like or similar designations in the drawings and description have been used to refer to like or similar parts of embodiments of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

A reflector lamp is generally provided, along with methods of forming such a lamp. Although shown as a PAR reflector lamp, it is to be understood that the present disclosure is applicable to any lamp or other device that incorporates a reflecting surface.

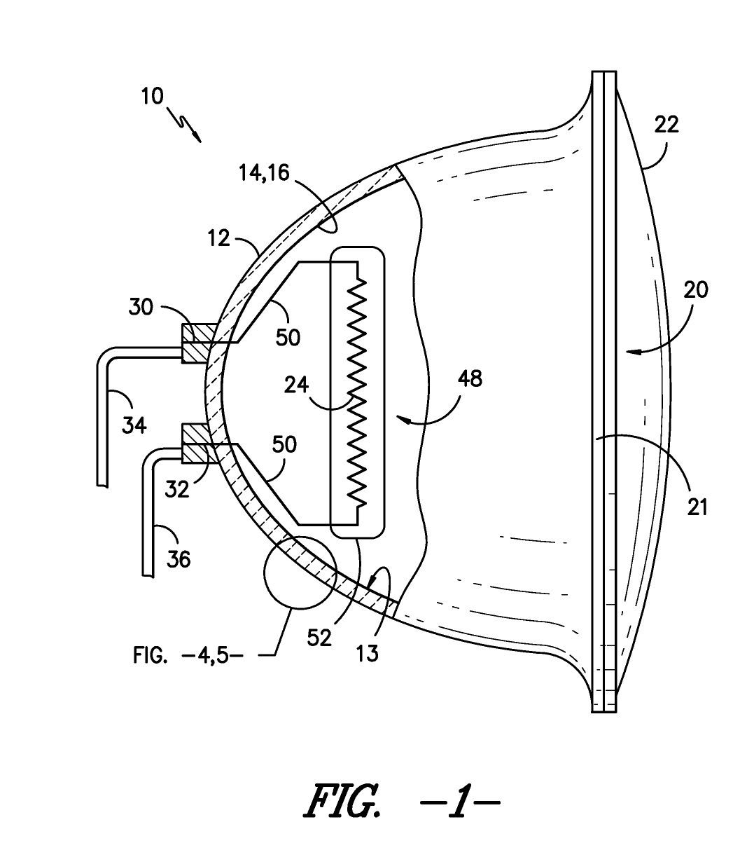

Referring to FIGS. 1-3, a lamp 10 is shown that includes a light source 48 positioned within a parabolic shaped housing 12. The housing 12 generally defines an interior surface 13 onto which an aluminum reflector layer 14 is applied. An optical interference multilayer coating 16 is deposited over the aluminum reflective layer 14. The optical interference multilayer coating 16 enhances the reflective properties of the aluminum reflective layer 14 on the interior surface 13 the housing 12, as is discussed in greater detail below. Additionally, the optical interference multilayer coating 16 can generally even out color variations seen on the reflective layer 14 of the housing 12 during use.

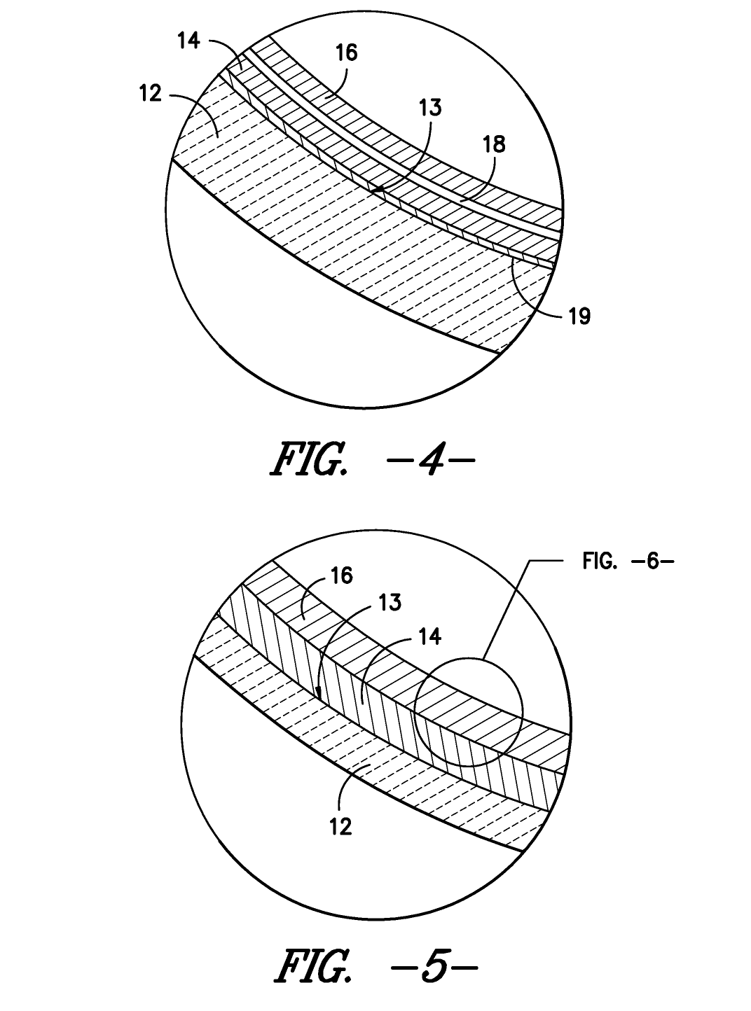

FIG. 4 shows an exploded view of the interior surface 13 of the housing 12 of the lamps 10 shown in FIGS. 1-3. As shown, the optical interference multilayer coating 16 is positioned on the aluminum reflective layer 14 to enhance the reflectiveness of the reflective layer 14. In particular, the optical interference multilayer coating 16 can increase the reflectivity of the aluminum reflective layer 14 to in turn increase the efficiency of the lamp 10. For example, the lamp efficiency can be increased to an efficiency of 90% or higher (e.g., about 91% to about 93%). Thus, the presence of the optical interference multilayer coating 16 on the aluminum reflective layer 14 allows the performance of an aluminum reflective layer 14 to meet and/or exceed the performance of a silver reflective coating on an otherwise identical lamp.

The optical interference multilayer coating 16 generally includes two different types of alternating layers, one having a low refractive index and the other having a greater or higher refractive index. As shown in FIG. 6, the optical interference multilayer coating 16 includes a low index layer 15 and a high index layer 17 (forming a pair of index matching layers) positioned on the reflector layer 14 on the interior surface 13 of the housing 12. In one embodiment, a plurality of pairs of index matching layers (i.e., a plurality of alternating low index layers 15 and high index layers 17) can be positioned on the reflector layer 14. Thus, the optical interference multilayer coating 16 is, in one particular embodiment, composed of a plurality of alternating low index layers 15 and high index layers 17, with the low index layers 15 have relatively low refractive index and the high index layers 17 have relative high refractive index (e.g., higher than the refractive index of the low index layers 15).

The refractive index (sometimes referred to as the index of refraction) of a substance is a measure of the speed of light in that substance, expressed as a ratio of the speed of light in vacuum relative to that in the considered medium. A simple mathematical description of the refractive index (n) is as follows:

n=velocity of light in a vacuum/velocity of light in medium.

As light exits the medium, it may also change its propagation direction in proportion to the refractive index (see Snell's law). By measuring the angle of incidence and angle of refraction of the light beam, the refractive index (n) can be determined. The refractive index of materials varies with the frequency of radiated light, resulting in a slightly different refractive index for each color. Unless otherwise stated, the values of refractive indices are calculated at a wavelength of 550 nanometers (nm). Such calculations are routinely performed in the art and methods of conducting them are readily known. One typical method of measuring these films is through the use of ellipsometry or spectroscopic ellipsometry (both techniques may include the use of multiple angles of incident light). For both techniques, the change in phase and polarization of a reference beam of light may be used to fit a model from which can be extracted the refractive index of the material.

The low index layers 15 can, in certain embodiments, have a refractive index that is about 1.38 to about 1.55 at 550 nm (e.g,. about 1.45 to about 1.55 at 550 nm). For example, the low index layers 15 can be a thin film layer including any suitable material, such as a silicon oxide (e.g., SiO and/or SiO₂), magnesium fluoride (MgF₂), lithium fluoride (LiF), calcium fluoride (CaF₂), sodium fluoride (NaF), other group I or group II fluorides, or mixtures thereof.

Alternatively, the high index layers 17 can have a refractive index that is greater than that of the low index layers 15. For example, the high index layers 17 can have a refractive index that is about 1.7 to about 2.8 at 550 nm (e.g., about 2.0 to about 2.7 at 550 nm). In certain embodiments, the high index layers 17 can have a refractive index of about 2.05 to about 2.4, such as about 2.1 to about 2.3. For instance, the high index layers 17 can be a thin film layer including any suitable material, such as a niobium oxide (e.g., Nb₂O₃ and/or Nb₂O₅), titanium dioxide (TiO₂), zinc sulfide (ZnS), tin oxide, zinc oxide, zinc tin oxide (ZTO), indium oxide (In₂O₃), hafnium oxide (HfO₂), tantalum pentoxide (Ta₂O₅), zirconium oxide (ZrO₂), yttrium oxide (Y₂O₃), ytterbium oxide (Yb₂O₃), silicon nitride (Si₃N₄), aluminum nitride (AlN), or mixtures thereof.

In one particular embodiment, the high index layer 17 can be a niobium oxide (e.g., Nb₂O₃ and/or Nb₂O₅), and the low index layer 15 can be a silicon dioxide (SiO₂) layer.

Although shown having only six total layers (i.e., three low index layers 15 and three high index layers 17, in alternating arrangement), any suitable number of alternating low and high index layers 15, 17 can form the optical interference multilayer coating 16. In certain embodiments, for instance, the optical interference multilayer coating 16 can have a total number of layers of about 4 to about 50, such as about 16 to about 40. In one particular embodiment, the optical interference multilayer coating 16 can have a total number of layers of about 24 to about 30, such as 26 layers (i.e., 13 of each of the low and high index layers 15, 17, in alternating arrangement) or 28 layers (i.e., 14 of each of the low and high index layers 15, 17, in alternating arrangement).

The thicknesses of the high index layer(s) 17 and the low index layer(s) 15 can be varied according to the materials in the layers. In most embodiments, the thickness of each of the high index layer(s) 17 and the low index layer(s) 15 can be about 100 nm to about 400 nm (e.g., about 150 nm to about 350 nm). In certain embodiments, the plurality of alternating low index layers 15 and high index layers 17 can form an optical interference multilayer coating 16 that has a total geometrical thickness of about 15 μm to about 15 μm (e.g., about 2 μm to about 10 μm). The thickness of the individual alternating layers 15,17 and the total thickness of the optical interference multilayer coating 16 can be controlled to provide a substantially flat reflectance curve across the entire visible wavelength range. Thus, this design differs from quarter-wavelength designs that rely on a reference wavelength.

The optical interference multilayer coating 16 can be formed via sequential deposition of the alternating low index layers 15 and high index layers 17, by any suitable technique that can provide sufficient control to the thickness of each layer during deposition. Particularly suitable deposition methods include vacuum deposition (e.g., sputtering), Ion-Assisted-Deposition (IAD), physical vapor deposition (PVD), or chemical vapor deposition (CVD), or by other known processes, such as thermal evaporation or dip coating.

As stated, the presence of the optical interference multilayer coating 16 can allow the aluminum reflector layer 14 to match or exceed the performance characteristics of a silver reflector layer on an otherwise identical lamp. As such, the aluminum reflector layer 14 can be generally constructed from aluminum, but may include additional materials.

The aluminum reflector layer 14 can be deposited by any suitable method, such as vacuum deposition methods (e.g., sputtering), Ion-Assisted-Deposition (IAD), physical vapor deposition (PVD), or chemical vapor deposition (CVD), or by other known processes, such as thermal evaporation or dip coating. For example, in one particular embodiment, the aluminum reflector layer 14 can be deposited via magnetron sputtering. In this process, a high energy inert gas plasma is used to bombard a target, such as aluminum. The sputtered atoms condense on the cold glass or quartz housing 12. DC (direct current) pulsed DC (40-400 KHz) or RF (radio frequency, 13.65 MHz) processes may be used. Ion assisted deposition is another method of depositing aluminum, which can be used in combination with another deposition technique, such as PVD Electron beam evaporation. The ion beam (e.g., produced by a Kaufman Ion gun, available from Ion Tech Inc.) is used to bombard the surface of the deposited film during the deposition process. The ions compact the surface, filling in voids, which could otherwise fill with water vapor and damage the film during subsequent heating steps.

No matter the deposition technique utilized, the aluminum reflector layer 14 can have a total thickness of about 0.05 μm to about 5 μm.

Other layers can also be included on the interior surface 13 of the housing 12, if desired. For example, an optional buffer layer 18 can be positioned between the reflector layer 14 and the optical interference multilayer coating 16, as shown in FIG. 4. Suitable materials for such a buffer layer 18 include silicon, titanium, tantalum, and the like, alone or in combination. Additionally, an intermediate layer 19 can optionally be interposed between the reflector layer 14 and the interior surface 13 of the housing 12, such as a layer of chromium, nickel, or alloys thereof (e.g., a nickel chromium alloy). Such an intermediate layer 19 may be used to improve the adherence of the aluminum reflector layer 14 to the quartz or glass surface 13 of the housing 12 or, the layer 19 may be used for other purposes, such as increasing the thickness of the reflective layer 14 to minimize the occurrence of pinhole openings in the film which allow light through to the rear of the housing 12.

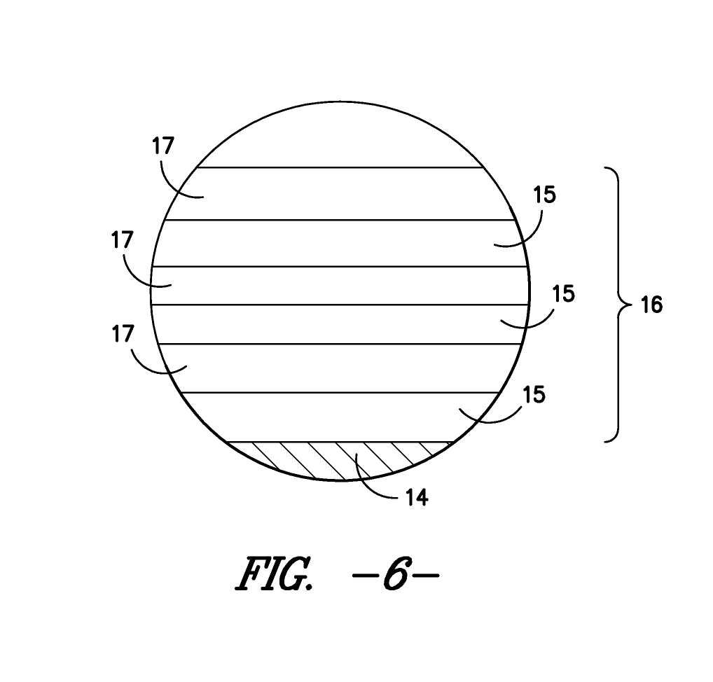

However, these optional layers may be omitted from the lamp 10 in certain embodiments. For example, in the alternative embodiment shown in FIG. 5, the reflector layer 14 is positioned directly onto the interior surface 13 of the housing 12 without any other layer present, while the optical interference multilayer coating 16 is positioned directly on the reflector layer 14 without any other layer present.

Referring again to FIGS. 1-3, each lamp 10 has a reflector housing 12 that includes a first end 21 having an opening 20 sealed with a lens 22. Lens 22 may be transparent to all light, may include a filter (not shown) to absorb/reflect the light dispersed by a filament 24, and/or may include an anti-reflection coating to enhance light transmission. In fact, lens 22 may be designed, as known in the art, to meet the particular requirements of the lamp 10.

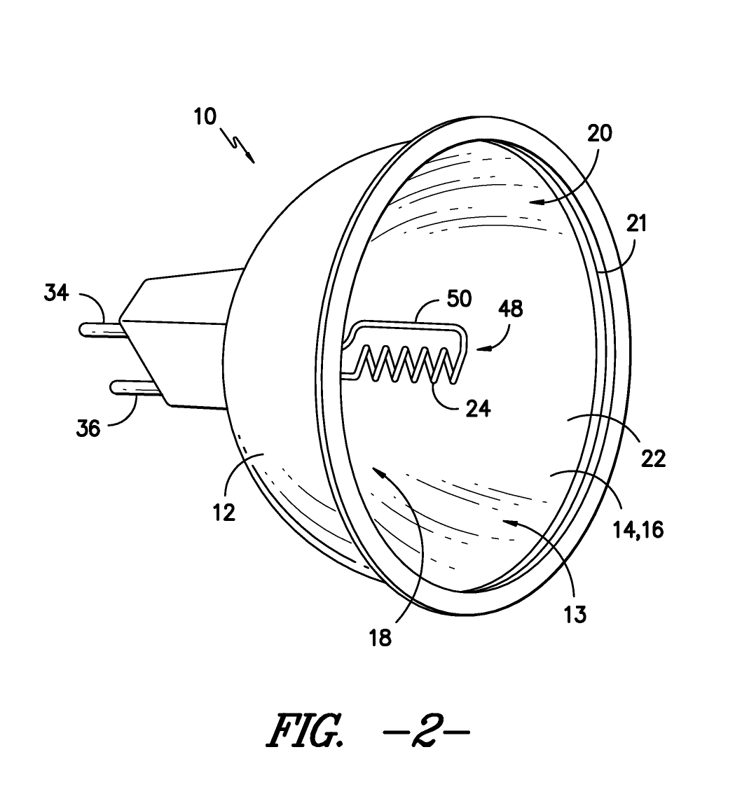

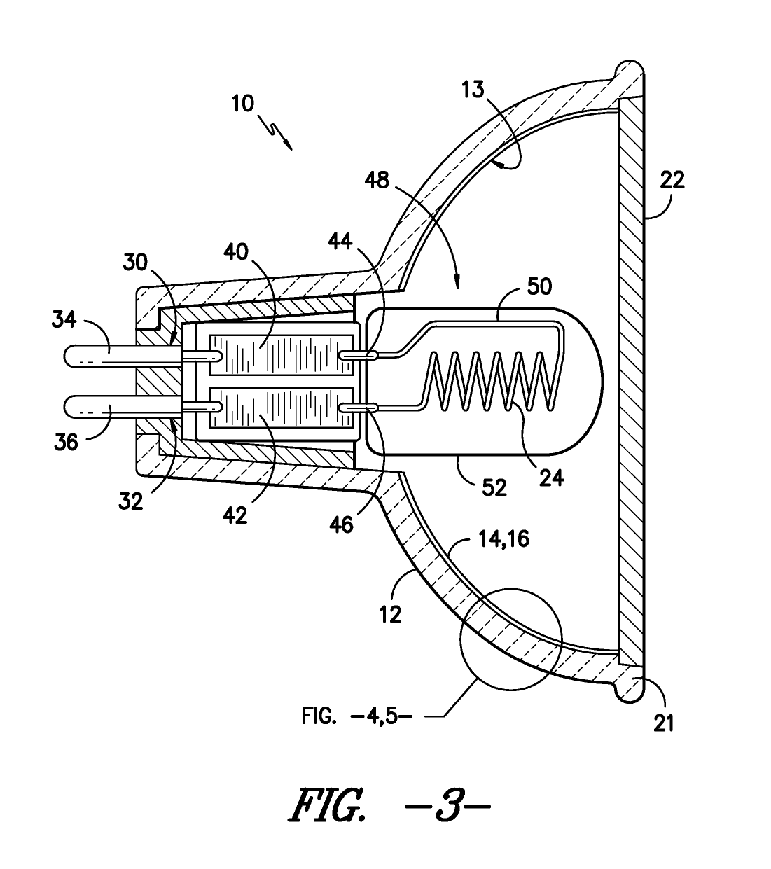

Leads 34 and 36 are in electrical connection the light source 48 in order to provide electricity thereto. As show, the light source 48 includes a filament support 50 and the filament 24. In the embodiment of FIG. 1, the filament light source 48 runs perpendicular to the central axis of a housing 12 with a filament midpoint positioned substantially on the focus of the parabola. However, any suitable light source 48 can be utilized in accordance with the present invention. For example, referring to the embodiment of FIGS. 2-3, the filament light source can be oriented parallel to the central axis of the housing 12.

As best shown in FIG. 3, the reflector housing 12 includes two pass-through channels 30 and 32, which accommodate leads or ferrules 34 and 36. Leads 34 and 36 are in electrical connection with foils 40 and 42, which in turn are in electrical connection with leads 44 and 46. In this manner, electricity is provided to a light source 48, comprising a filament support 50 and the filament 24.

In one particular embodiment, the lens 22 is can be sealed (e.g,. flame sealed) to the reflector housing 12 to create a hermetic chamber, such as shown in FIGS. 1 and 3. The atmosphere or fill of housing 12 comprises, in certain embodiments, at least one inert gas, such as krypton, helium, or nitrogen.

Alternatively, as shown in FIG. 3, the light source 48 can house the filament 24 within its own contained atmosphere utilizing an envelope 52.

Method are also generally provided for forming a reflector lamp, such as those lamps 10 shown in FIGS. 1-3. For example, the aluminum reflector layer can be first formed (e.g., deposited) on the interior surface of the housing, and then alternating low index layers and high index layers can be deposited to form an optical interference multilayer coating on the reflective layer. A light source can be positioned within the housing, either before or after the deposition of the layers, depending on the particular lamp configuration. The housing can then be sealed by securing a lens onto the opening of the parabolic housing.

In the present disclosure, when a layer is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of since the relative position above or below depends upon the orientation of the device to the viewer. Additionally, although the invention is not limited to any particular film thickness, the term “thin” describing any film layers generally refers to the film layer having a thickness less than about 10 micrometers (“microns” or “μm”).

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

It is to be understood that the ranges and limits mentioned herein include all sub-ranges located within the prescribed limits, inclusive of the limits themselves unless otherwise stated. For instance, a range from 100 to 200 also includes all possible sub-ranges, examples of which are from 100 to 150, 170 to 190, 153 to 162, 145.3 to 149.6, and 187 to 200. Further, a limit of up to 7 also includes a limit of up to 5, up to 3, and up to 4.5, as well as all sub-ranges within the limit, such as from about 0 to 5, which includes 0 and includes 5 and from 5.2 to 7, which includes 5.2 and includes 7.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

1. A reflector lamp, comprising:
a housing defining an interior surface;
a light source positioned within the housing;
a reflector layer on the interior surface of the housing, wherein the reflector layer comprises aluminum; and
an optical interference multilayer coating on the reflective layer,
wherein the optical multilayer coating comprises a plurality of alternating low index layers and high index layers, the low index layers having a refractive index that is about 1.38 to about 1.55 at 550 nm and the high index layers having a higher refractive index than the low index layers, wherein the high index layers comprise a niobium oxide, tin oxide, zinc oxide, zinc tin oxide, indium oxide, hafnium oxide, tantalum pentoxide, zirconium oxide, yttrium oxide, ytterbium oxide, silicon nitride, aluminum nitride, or mixtures thereof; and
wherein a thickness of the individual alternating low index layers and high index layers and a total thickness of the optical interference multilayer coating are controlled to provide a substantially flat reflectance curve across the visible wavelength range.

2. The reflector lamp as in claim 1, wherein the low index layers have a refractive index that is about 1.45 to about 1.55 at 550 nm.

3. The reflector lamp as in claim 1, wherein the low index layers comprise a silicon oxide, magnesium fluoride, lithium fluoride, calcium fluoride, sodium fluoride, other group I or group II fluorides, or mixtures thereof.

4. The reflector lamp as in claim 1, wherein said high index layers have a refractive index that is about 1.7 to about 2.8 at 550 nm.

5. (canceled)

6. The reflector lamp as in claim 1, wherein the high index layers comprise a niobium oxide.

7. The reflector lamp as in claim 1, further comprising:
an intermediate layer between the reflector layer and the interior surface of the housing.

8. The reflector lamp as in claim 1, further comprising:
a buffer layer positioned between the reflector layer and the optical interference multilayer coating.

9. The reflector lamp as in claim 1, wherein the optical interference multilayer coating has a total number of layers of about 6 to about 50.

10. The reflector lamp as in claim 1, wherein each of the low index layers and the high index layers has a geometrical thickness of about 100 nm to about 400 nm.

11. The reflector lamp as in claim 1, wherein the optical interference multilayer coating has a geometrical thickness of about 1 μm to about 15 μm.

12. The reflector lamp as in claim 1, wherein the alternating low index layers and high index layers improve the reflectivity of the reflector layer.

13. The reflector lamp as in claim 1, further comprising:
a lens closing the housing.

14. A method of forming a reflector lamp, comprising:
forming a reflector layer on the interior surface of the housing, wherein the reflector layer comprises aluminum;
depositing alternating low index layers and high index layers to form an optical interference multilayer coating on the reflective layer, the low index layers having a refractive index that is about 1.38 to about 1.55 at 550 nm and the high index layers having a higher refractive index than the low index layers, wherein high index layers comprise a niobium oxide, tin oxide, zinc oxide, zinc tin oxide, indium oxide, hafnium oxide, tantalum pentoxide, zirconium oxide, yttrium oxide, ytterbium oxide, silicon nitride, aluminum nitride, or mixtures thereof; and
positioning a light source within the housing.

15. The method as in claim 14, wherein the alternating low index layers and high index layers improve the reflectivity of the reflector layer.

16. The method as in claim 14, wherein the low index layers have a refractive index that is about 1.45 to about 1.55 at 550 nm.

17. The method as in claim 14, wherein the low index layers comprise a silicon oxide.

18. The method as in claim 14, wherein said high index layers have a refractive index of from about 1.7 to about 2.8 at 550 nm.

19. The method as in claim 14, wherein the high index layers comprise a niobium oxide.
